(19) United States
(12) Patent Application Publication
(10) Pub. No.: US 2002/0147504 A1
(43) Pub. Date: Oct. 10, 2002

(54) Remote monitoring and controlling system for remotely monitoring and controlling illumination loads

(75) Inventors: Shinji Sakasegawa, Tsu-shi (JP); Mototsugu Kawamata, Tsu-shi (JP); Toshiaki Tokizane, Tsu-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MATSUSHITA ELECTRIC WORKS, LTD., Kadoma-shi (JP)

(21) Appl. No.: 10/093,387

(22) Filed: Mar. 11, 2002

(30) Foreign Application Priority Data
Mar. 23, 2001 (JP) P2001-85524

(51) Int. Cl. G05B 15/02

(52) U.S. Cl. 700/9

(57) ABSTRACT

In a remote monitoring and controlling system, a selector switch unit sets data for batch controlling and separately controlling operation of illumination loads and transmitting to the signal line a control request signal related to operation for the illumination loads based on the set data. A data memory stores therein set operation states of respective illumination loads and set dimming levels of respective illumination loads so that the operation states and the dimming levels are associated in correspondence therebetween. A control request signal containing the data stored in the data memory is transferred to a terminal unit. The terminal unit transmits a dimming-level instruction signal to its corresponding dimming terminal unit based on a control request signal of dimming level from the selector switch unit, and further transmits a display instruction signal of dimming level to the selector switch unit, thereby displaying a current dimming level.

### BACKGROUND OF THE INVENTION

1. Field of the Invention

The present invention relates to remote monitoring and controlling systems for remotely monitoring and controlling illumination loads, and in particular, the present invention relates to a remote monitoring and controlling system capable of monitoring and instruction of operations for illumination loads provided in this system and of batch-controlling a plurality of illumination loads with one switch unit.

2. Description of the Related Art

Conventionally, there has been provided a remote monitoring and controlling system in which, as shown in FIG. 13, a plurality of terminal units 42 and 43 are connected to a transmission unit 41 via a two-wire signal line 44 and illumination loads L are controlled according to operation of switches SW provided in the terminal units (hereinafter, referred to as operation terminal units) 42 via relays 45 provided in the terminal units (hereinafter, referred to as control terminal units) 43. The terminal units 42 and the terminal units 43 have addresses set to themselves, respectively. When monitoring data effectuated by an operation of a switch SW is inputted to an operation terminal unit 42, the monitoring data is transmitted to the transmission unit 41. Upon receiving the monitoring data, the transmission unit 41 transmits control data responsive to the monitoring data to a control terminal unit 43 set in a corresponding relation to the operation terminal unit 42 by an address, so that the illumination load L is controlled. The transmission unit 41, the operation terminal units 42 and the control terminal units 43 each include a microprocessor as a main component.

Further, an external interface terminal unit 47 and a pattern-setting terminal unit 48 are connected to the signal line 44. In this case, the external interface terminal unit 47 is a terminal unit that performs data transmission with an external control unit 47a, and the pattern-setting terminal unit 48 is a terminal unit that transfers to the transmission unit 41 pattern control data inputted from a data input section 48a. It is to be noted that the operation terminal units 42 and the control terminal units 43 disposed within a distribution board 46 or relay control board 46a are sized in conformity to the agreed sizes of distribution boards.

The transmission unit 41 transmits to the signal line 44 a transmission signal Vs of such a form as shown in FIGS. 14A and 14B. More specifically, the transmission signal Vs is a bipolar ((±24 V) time-division multiplexed signal composed of a start pulse signal SY representing a start of signal transmission, a mode data signal MD representing a signal mode, an address data signal AD for transmitting address data used to individually call up the operation terminal units 42 or the control terminal units 43, a control data signal CD for transmitting control data used to control illumination loads, a check sum data signal CS for detecting transmission errors, and a signal return time interval WT that is a time slot for receiving return signals from the operation terminal units 42 or the control terminal units 43, where data is transmitted by pulse width modulation.

In each of the operation terminal units 42 and the control terminal units 43, if address data of the transmission signal Vs received via the signal line 44 coincides with address data that have been set for those units, respectively, then the unit captures control data from the transmission signal Vs and besides, in synchronization with the signal return time interval WT of the transmission signal Vs, returns monitoring data as a current-mode signal (a signal transmitted by short-circuiting the signal line 44 with via an appropriate low impedance).

Also, the transmission unit 41 is equipped with continuous polling means that performs continuous polling in which address data contained in the transmission signal Vs is continuously changed cyclically so that the operation terminal units 42 and the control terminal units 43 are sequentially accessed. In the continuous polling, an operation terminal unit 42 or a control terminal unit 43 that has coincided with address data contained in the transmission signal Vs captures control data contained in the transmission signal Vs. Further, the transmission unit 41 is also equipped with interrupt polling means which operates in a manner that when having received such an interrupt signal Vi as shown in FIG. 14(c) generated from some operation terminal unit 42, the interrupt polling means detects the operation terminal unit 42 that has generated the interrupt signal, and then accesses the operation terminal unit 42 so as to make the unit return monitoring data.

That is, the transmission unit 41 continuously transmits to the signal line 44 a transmission signal Vs in which the address data is changed cyclically by the continuous polling means, where when an interrupt signal Vi generated from an operation terminal unit 42 is detected in synchronization with the start pulse signal SY of the transmission signal Vs, a transmission signal Vs in which the mode data signal MD has been set to the interrupt polling is transmitted from the transmission unit 41 by the interrupt polling means. The operation terminal unit 42 that has generated the interrupt signal Vi, upon the address thereof being coincidence with higher-order bits of the address data of the transmission signal Vs of the interrupt polling mode, returns lower-order bits of the address data set to the operation terminal unit 42 in synchronization with the signal return time interval WT of the transmission signal Vs as reply data. In this way, the transmission unit 41 acquires the address of the operation terminal unit 42 that has generated the interrupt signal Vi, and accesses the operation terminal unit 42 with the acquired address to receive, as reply data, operation data corresponding to the operation state of the switch SW connected to the operation terminal unit 42. On the other hand, if the low-order address is not returned from the operation terminal unit 42 that has generated the interrupt signal Vi, the interrupt polling means in the transmission unit 41 re-transmits the transmission signal Vs of the interrupt polling mode with the high-order address changed.

In this way, when the transmission unit 41 has acquired the address of the operation terminal unit 42 that has generated the interrupt signal Vi, the transmission unit 41 transmits a transmission signal Vs which requests return transmission of monitoring data from the operation terminal unit 42, and the operation terminal unit 42 returns to the transmission unit 41 monitoring data corresponding to operation of switch SW. The transmission unit 41 that has received the monitoring data generates control data for a control terminal machine 43 previously set in correspondence to the operation terminal unit 42 by the correspondence of addresses, and transmits to the signal line 44 a transmission signal Vs containing this control data to control the illumination load L through the control terminal machine 43. It is to be noted here that the address of the operation terminal units 42 and the control terminal units 43 consists of a channel which discriminates a terminal unit and an illumination load number which discriminates a circuit of switch SW and illumination load L. In existing products, 64 channels are provided and four circuits of illumination load numbers are set every channel. That is, a channel is set every operation terminal unit 42 and control terminal unit 43, and up to four circuits of switches SW or illumination loads L are connectable to each of the operation terminal units 42 and the control terminal units 43. Therefore, a total of 256 circuits of illumination loads L are controllable.

In this type of remote monitoring and controlling system, there are available separate control in which switches SW and illumination loads L are in one-to-one correspondence as well as batch control in which a plurality of illumination loads L are associated with one switch SW so that a plurality of illumination loads L are batch controlled by operation of one switch SW. Also, when the control terminal units 43 are capable of dimming and controlling the illumination loads L, dimming control of the illumination loads L can be achieved by operation of the operation terminal units 42. As to the batch control, available are group control in which a plurality of illumination loads L are controlled to an identical state as well as pattern control in which a plurality of illumination loads L are set to previously set control states respectively and separately. Thus, the switches SW control the illumination loads L by any one of the control methods among separate control, group control, pattern control and dimming control. The correspondence relation of addresses (channel+illumination load number) between the operation terminal units 42 and the control terminal units 43 is one-to-one correspondence in the separate control, and one-to-multi correspondences in the group control and the pattern control. Also, the dimming control is in either the separate control or the batch control.

Individual address is given to each control terminal unit 43, and the address is constituted by a channel number and a load number. An address corresponding to the type of control (separate control, pattern control and group control) is given to each operation terminal unit 42. In the separate control, an address of a channel number and a load number is given in a manner similar to that of the control terminal unit 43. In the pattern control, an address (Px) of a pattern number is given, and in the group control, an address (Gx) of a group number is given.

The correspondence relation between switches SW and illumination loads L in the separate control or the batch control as described above is set in a relation data storage section provided in the memory of the transmission unit 41. That is, in the installation work, the correspondence relation between switches SW and illumination loads L is set in the relation data storage section after addresses are completely set to the individual operation terminal units 42 and control terminal units 43, where it becomes possible to control a desired illumination load L in response to operation of a switch SW. In this case, the correspondence between switches SW and illumination loads L in the separate control is set to a correspondence of identical addresses, and setting addresses to the operation terminal units 42 and the control terminal units 43 allows a correspondence between switches SW and illumination loads L to be set automatically. It is noted here that the operation terminal units 42 and the control terminal units 43 are distinguished from each other by data of terminal unit type. Meanwhile, since the work of setting the correspondence between switches SW and illumination loads L in the batch control becomes complicated when done by using the switches SW, it has conventionally been practiced to provide a selector switch unit 50 having a constitution as shown in FIG. 15 in order to facilitate the work of setting to the relation data storage section the correspondence between switches SW and illumination loads L in the batch control.

The selector switch unit 50 shown in FIG. 15 has selection switches SS which can be assigned to the switches SW corresponding to a number of circuits manageable by the transmission unit 41 (i.e., registrable to the relation data storage section). However, since the transmission unit 41 is capable of 256 circuits of switches SW as described above, providing 256 selection switches SS would cause the selector switch unit 50 to be considerably enlarged. Thus, in the selector switch unit 50 shown in FIG. 15, on a basis of four selection switches SS per channel, 64 selection switches SS for 16 channels are provided, where each one selection switch SS is set in correspondence to four circuits. Each selection switch SS is set in correspondence to an operation display section 51 composed of two light-emitting diodes LD1 and LD2. Also, one channel display section 52 is provided every four selection switches SS for one channel. Four numerals are provided at each channel display section 52, and each one of those numerals is to be turned on and displayed alternatively by selecting one. In this case, the channel display section 52 is composed of a plurality of plane light-emitting diodes corresponding to the numerals, respectively. In this way, one selection switch SS is made to correspond to four channels. Which channel of the four channels is made to correspond to each selection switch SS is selected by a channel selector switch unit S21 disposed within a door 61 provided on the front side of a housing 60 of the selector switch unit 50. That is, each time the channel selector switch unit S21 is pressed once, the numerals of 0 to 15, 16 to 31, 32 to 47 and 48 to 63 are turned on and displayed in order at the channel display section 52. In such an arrangement as described above, a function equivalent to 256 circuits of switches SW can be realized with 64 selection switches SS.

All of the selection switches SS in the selector switch unit 50 serve as switches SW for separate control, and such batch control as pattern control and group control cannot be executed by using the selection switches SS. That is, switches SW which give monitoring data to the operation terminal units 42 connected to the signal line 44 are used for the switches SW serving for pattern control or group control. Thus, for selection as to which switches SW are used for pattern control or group control, an address selection switch S22 is disposed within the door 61 of the housing 60. The address selection switch S22 functions to select an address of 3 digits, digit by digit, and a selected address is displayed at a display section 53 composed of seven-segment light-emitting diodes.

Also, selection of pattern control or group control is done by operating either a pattern selection switch S23 or a group selection switch S24. That is, in order that illumination loads L to be batch controlled in pattern control or group control are associated in correspondence with the switches SW, the classification of pattern control or group control is first selected by operating either one of the pattern selection switch S23 and the group selection switch S24, and further an address is selected by the address selection switch S22 to set a pattern address or a group address. Thereafter, illumination loads L to be batch controlled are selected by using the selection switches SS or the like.

The selector switch unit 50 is also provided with an all-on switch S12, an all-off switch S13 and an all-outside-area switch S14. The all-on switch S12 has a function of turning ON all the illumination loads L. Therefore, in the case where many illumination loads L are to be turned ON in the setting of pattern control, operating the all-on switch S12 before operating the selection switches SS to select only the illumination loads L that should be turned OFF allows the number of times of operation of the selection switches SS to be lessened. The all-on switch S12 can be used also in the setting of group control. Further, the all-off switch S13 has a function of turning OFF all the illumination loads L, and can be used in the case where many illumination loads L are to be turned OFF in the setting of pattern control. The all-outside-area switch S14 functions to exclude all the illumination loads L from the control objects of group control in the setting of group control.

The selector switch unit 50 is used for the setting of batch control as described above, and moreover the selection switches SS can be used also for the control in the case of separate control. Switching between the setting use and the control use is performed by a mode selector switch unit S26, which is a slide switch.

The contents of the batch control set by the selector switch unit 50 are once stored in a memory provided in the selector switch unit 50. However, for actually using the contents for control of the illumination loads L, the contents need to be transferred to the relation data storage section of the transmission unit 41. Therefore, an output switch S27 for instructing transfer of set data to the transmission unit 41 is provided in the selector switch unit 50. Also, for example, for changing the setting contents of the relation data storage section, capturing and correcting the data that has been set in the relation data storage section of the transmission unit 41 facilitates the setting work. Therefore, an input switch S28 for instructing the data transfer from the relation data storage section to the selector switch unit 50 is also provided. Further, when an error is displayed in the display section 53 due to some misconnection or misoperation, the internal state of the selector switch unit 50 can be initialized by operating a reset switch S29.

The pattern selection switch S23, the group selection switch S24, the output switch S27 and the input switch S28 as described above are further equipped with a display section 54 composed of light-emitting diodes that are turned on in operation to show that a state selected by its operation is continuing.

The selector switch unit 50 described above is a fixed type one for use in a wall-mounted or other form. Since the front face of the housing 60 is large in size, not only a large number of selection switches SS but also a multiplicity of the operation display sections 51 and the channel display sections 52 can also be arranged. Thus, the checking of the setting state of the whole in pattern control or group control can be easily achieved.

Meanwhile, there has been recently an increasing demand for, with an illumination load used as the illumination load L, enabling the regulation of optical output of the illumination load in order to obtain a more comfortable indoor illumination environment or to change indoor atmosphere with illumination. As a result, there has been a demand for setting and controlling the dimming level of the illumination load as well even in the pattern control or group control.

However, since the aforementioned selector switch unit 50 is such that each selection switch SS only has a function as a switch SW for each circuit (address), it is impossible to set the dimming level, thus not ready for the pattern control or the group control including the dimming control as it stands.

### SUMMARY OF THE INVENTION

An essential object of the present invention is therefore to provide a remote monitoring and controlling system capable of setting and controlling for separate control and batch control including dimming control.

Another object of the present invention is to provided a remote monitoring and controlling system capable of setting multiple circuits easily and also of centralized control of all illumination loads with one selector switch unit.

In order to achieve the aforementioned objective, according to one aspect of the present invention, there is provided a remote monitoring and controlling system provided with a selector switch unit connected to a signal line. The selector switch unit has a predetermined address, and the selector switch unit sets data for batch controlling and separately controls operation of a plurality of illumination loads and transmitting to the signal line a control request signal related to operation for the plurality of illumination loads based on the set data. A transmission unit is connected to the signal line, and transmits and receives a transmission signal to and from a plurality of dimming terminal units by using a preliminarily set correspondence relation of addresses between operation terminal units and the dimming terminal unit based on a control request signal derived from the selector switch unit. A plurality of dimming terminal units are connected to the signal line, and have predetermined addresses, respectively. The plurality of dimming terminal units controls dimming of illumination loads connected in correspondence to the individual dimming terminal units, respectively, in response to a transmission signal derived from the transmission unit.

The selector switch unit is provided with first to third operation units. The first operation unit is provided in correspondence to the plurality of illumination loads and equipped with a plurality of switches for inputting and setting operations of the plurality of illumination loads. The second operation unit is provided for inputting and setting correspondence between at least one of the plurality of switches and at least one illumination load. The third operation unit is provided for inputting and setting dimming levels of illumination loads in a unit of at least one illumination load among the illumination loads to which their operations and correspondence relation have been set by the first and second operation units.

A display unit displays setting contents and dimming levels set by the first to third operation units. A data memory stores therein operation states of the respective illumination loads set by the first and second operation units and dimming levels of the respective illumination loads set by the third operation unit, so that the operation states and the dimming levels are associated in correspondence therebetween. A transfer unit transfers a control request signal containing the data stored in the data memory to the terminal unit.

The terminal unit transmits a dimming-level instruction signal to its corresponding dimming terminal unit based on a control request signal of dimming level derived from the selector switch unit, and further transmits a display instruction signal of dimming level to the selector switch unit, thereby displaying a current dimming level on the display unit.

In the above-mentioned remote monitoring and controlling system, preferably, the dimming level has a plurality of steps, and changes in optical output from an illumination load between mutually adjacent steps are set so as to be visually recognizable.

In the above-mentioned remote monitoring and controlling system, preferably, the selector switch unit receives a dimming level contained in a transmission signal transmitted from the transmission unit to the dimming terminal unit and stores the dimming level into the data memory.

In the above-mentioned remote monitoring and controlling system, preferably, with operation states of a plurality of illumination loads stored and set to the data memory, and under control of dimming levels of a plurality of illumination loads based on the transmission signal, the selector switch unit comprises a first scene storage unit for receiving from the transmission signal a dimming level for each of the illumination loads the operation state of which has been set to ON state in the data memory and for setting the dimming level to the data memory.

In the above-mentioned remote monitoring and controlling system, preferably, with operation states of a plurality of illumination loads inputted and set by the first operation unit, and under control of dimming levels of a plurality of illumination loads based on the transmission signal, the selector switch unit comprises a second scene storage unit for receiving from the transmission signal an operation state and a dimming level for the plurality of illumination loads the operation state of which has been set to ON state in the data memory and for setting the operation state and dimming level to the data memory.

In the above-mentioned remote monitoring and controlling system, preferably, the second operation unit comprises a selection unit for selecting and setting a fade operation mode in which optical output from each illumination load is increased or decreased with time elapse. The data memory further stores fade time showing a rate of change of optical output per unit time in the fade mode. The transmission unit transmits a dimming level instruction signal to its corresponding dimming terminal unit based on a control request signal of dimming level containing the stored fade time derived from the selector switch unit so that a corresponding illumination load executes fade operation.

According to the present invention, the remote monitoring and controlling system enables the setting and control for separate control and batch control including dimming control, and yet allows the setting for multiple circuits to be easily achieved, and moreover enables the centralized control of all the illumination loads with one selector switch unit, which is convenient for operational verification of setting contents.

Since the remote monitoring and controlling system eliminates the possibility of more than necessary multi-step switching in the setting of dimming level and allows the dimming level to be set in such a coarse one as can be recognized visually, the remote monitoring and controlling system serves practical use and facilitates the setting operation for dimming level. In particularly, with the use of an operation section in which the dimming level changes one step for each one press in the setting of dimming level, whereas multi-steps would take time and labor until a desired dimming level is reached, lessening the steps for setting the dimming level allows the time and labor to be reduced until a desired dimming level is attained.

Since the dimming level contained in the transmission signal transferred from the transmission unit to the control terminal unit is stored into the data memory, it becomes possible to set a dimming level on confirmation of actual optical output of the illumination load.

In the present remote monitoring and controlling system, with ON/OFF states of batch-control targets preliminarily determined, optical output of the set-ON illumination loads is actually adjusted before the dimming levels of the turned-ON illumination loads are acquired from the transmission signal and set to the data memory. Thus, it becomes possible to prepare data for batch control including dimming control on confirmation of actual brightness.

In the present remote monitoring and controlling system, with illumination loads of batch-control targets preliminarily determined, the individual illumination loads are turned ON and OFF or optical output is adjusted, actually, before illumination load's ON/OFF and dimming level data only of the control-targeted illumination loads are acquired from the transmission signal and set to the data memory. Thus, it becomes possible to prepare data for batch control including dimming control on actual confirmation of control contents. Further, batch control including fade control becomes implementable.

### BRIEF DESCRIPTION OF THE DRAWINGS

These and other objects and features of the present invention will become clear from the following description taken in conjunction with the preferred embodiments thereof with reference to the accompanying drawings throughout which like parts are designated by like reference numerals, and in which:

FIG. 1 is a front view showing a selector switch unit 1 of a remote monitoring and controlling system according to a preferred embodiment of the present invention;

FIG. 2 is a block diagram showing the selector switch unit 1 of the remote monitoring and controlling system according to the preferred embodiment of the present invention;

FIG. 3 is a conceptual view of a data memory 36 for use in the selector switch unit 1 of the remote monitoring and controlling system according to the preferred embodiment of the present invention;

FIG. 4 is a conceptual view of the dimming level in the selector switch unit 1 of the remote monitoring and controlling system according to the preferred embodiment of the present invention;

FIGS. 5A, 5B, 5C and 5D are explanatory views showing operations of the selector switch unit 1 of the remote monitoring and controlling system according to the preferred embodiment of the present invention;

FIGS. 6A, 6B and 6C are explanatory views showing operations of the selector switch unit 1 of the remote monitoring and controlling system according to the preferred embodiment of the present invention;

FIG. 7 is a conceptual view of a data memory 36 of the selector switch unit 1 of the remote monitoring and controlling system according to a preferred embodiment of the present invention;

FIG. 8 is a flowchart showing an operation of the selector switch unit 1 of the remote monitoring and controlling system according to the preferred embodiment of the present invention;

FIG. 9 is a view showing a data format of a signal for use in the selector switch unit 1 of the remote monitoring and controlling system according to the preferred embodiment of the present invention;

FIG. 10 is a timing chart of a signal flow showing an operation of the selector switch unit 1 of the remote monitoring and controlling system according to the preferred embodiment of the present invention;

FIG. 11 is a timing chart of a signal flow showing a control operation of the remote monitoring and controlling system according to a preferred embodiment of the present invention;

FIG. 12 is a timing chart of a signal flow showing a modification of the control operation of the remote monitoring and controlling system according to the preferred embodiment of the present invention;

FIG. 13 is a block diagram showing a constitutional example of a remote monitoring and controlling system of a prior art;

FIG. 14 is a timing chart of signals showing an operation of the remote monitoring and controlling system shown in FIG. 13; and

FIG. 15 is a front view showing a prior art example of a selector switch unit of the remote monitoring and controlling system shown in FIG. 13.

### DETAILED DESCRIPTION OF THE PREFERRED EMBODIMENTS

Preferred embodiments according to the present invention will be described below with reference to the attached drawings.

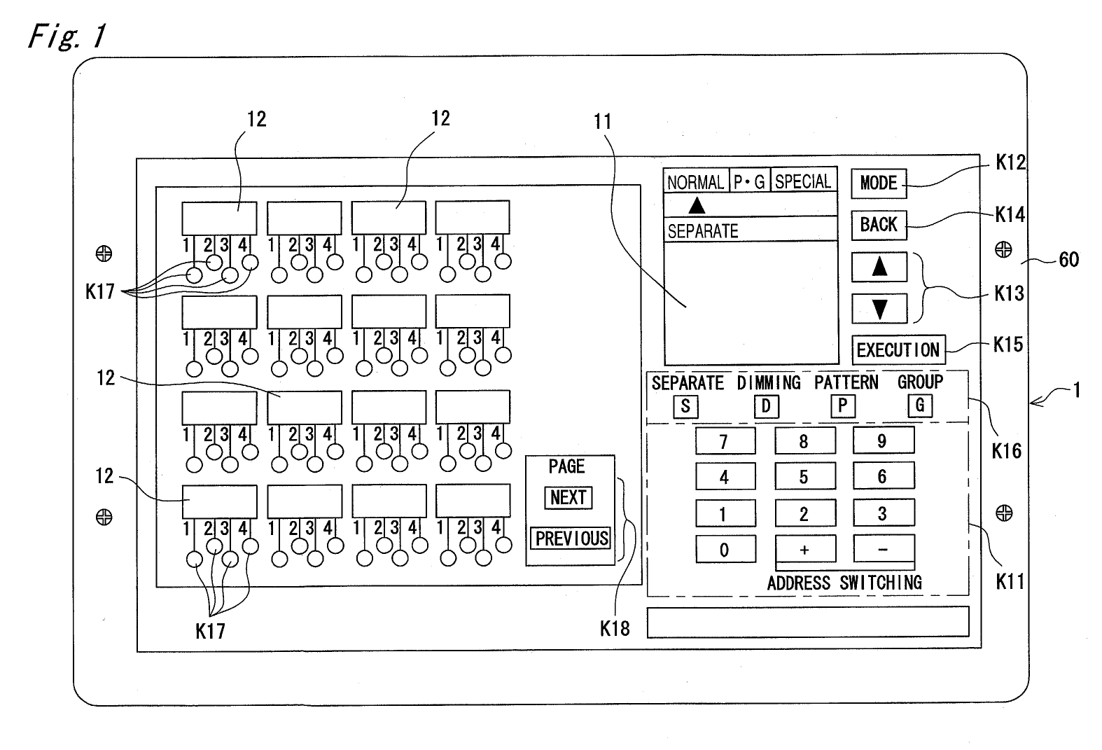

First of all, a constitution of a selector switch unit 1 of this remote monitoring and controlling system will be explained. Referring to FIG. 1, the selector switch unit 1 displays, on one display unit 11 formed of a liquid crystal display, the display contents of the display sections (display section 53 and display section 54) corresponding to various types of switches that have been disposed within the door 61 in the selector switch unit 50 of the prior art apparatus, and further the selector switch unit 1 displays on display units 12 formed of liquid crystal displays the display contents of the operation display section 51 and the channel display section 52 in the prior art apparatus. In this case, the display units 12 are provided channel by channel, and totally sixteen display units 12 are provided. The display units 11 and 12 are both of dot matrix type. In the present preferred embodiment, the all-on switch S12, the all-off switch S13, the all-outside-area switch S14, the output switch S27, the input switch S28 and the reset switch S29 are not provided, while a ten key K11 is provided in place of the address selection switches S22. Further, the mode selector switch unit S26 is replaced with a mode key K12 which is to be pressed instead of being a slide switch. The functions that have been implemented by the all-on switch S12, the all-off switch S13, the all-outside-area switch S14, the output switch S27 and the input switch S28 are made selectable on the screen of the display unit 11, where functions that have not been implemented by the prior art apparatus are also made selectable on the screen of the display unit 11. Further, the present preferred embodiment is also compatible with dimming terminal units 2, which are the control terminal units 43 for performing dimming control.

Pressing the mode key K12 causes a plurality of options to be displayed cyclically on the display unit 11. In this case, one of the options is reversely displayed. Up and down arrow keys K13 are provided beside the display unit 11, and pressing the arrow keys K13 causes the position of the reverse display of the option to be moved up and down. Also beside the display unit 11 are disposed a back key K14 and an execution key K15, and pressing the execution key K15 with a desired option reversely displayed causes the content of the reversely-displayed option to be selected. Functions for performing the setting of pattern control or group control are integrated in one screen, in which screen the functions of the pattern selection switch S23 and the group selection switch S24 or the like in the prior art apparatus are implemented by using function selection keys K16 arrayed above the ten key K11, and further functions equivalent to the address selection switches S22 of the prior art apparatus are implemented by using the ten key K11. The function selection keys K16 include keys that enable the selection of separate control and dimming control in addition to the selection of pattern control and group control. Another screen allows “ALL ONE”, “ALL OFF”, “ALL OUTSIDE AREA” or the like to be selected thereon, where this screen implements the functions of the all-on switch S12, the all-off switch S13 and the all-outside-area switch S14. Screen contents of the display unit 11 are hierarchized so that each one press of the back key K14 allows the screen to be turned back to one higher order screen. That is, the keys K11-K16 function as the first operation unit and the third operation unit.

Meanwhile, each display unit 12 is set in correspondence to four selection keys K17, the display unit 12 being enabled to display channels that correspond to one set of four selection keys K17. The selection keys K17 function as the first operation unit, being equivalent to the selection switches SS of the prior art apparatus. Although the display units 12 count sixteen in number, each display unit 12 displays four channels alternatively to selectively display one channel so as to be capable of up to 64 channels. Under the area where the display units 12 are arrayed in the front face of the housing 60, are provided page keys K18 for selecting among the four channels displayed on each display unit 12. That is, the channel to be displayed on the display units 12 can be switched by pressing the page keys K18. Each display unit 12 has areas for displaying symbols of “O” and “X” in correspondence to the four selection keys K17, where the “O” symbol represents an OFF state of an illumination load and the “X” symbol represents an OFF state of an illumination load. That is, these symbols implement the functions of the operation display section 51 of the prior art apparatus. Thus, the functions of the operation display section 51 and the channel display section 52 in the prior art apparatus can be implemented by the display units 12. Consequently, the display units 11 and 12 function as display unit.

As apparent from FIG. 1, in the present preferred embodiment, the selection keys K17 are arrayed not on a lateral straight line but in such an arrangement that left-and-right adjacent selection keys K17 are shifted up and down directions. That is, with respect to a left-end selection key K17, its right-adjacent selection key K17 is placed above the left-end selection key K17, a one-more right-adjacent selection key K17 is placed at the same vertical position as that of the left-end selection key K17, and the right-end selection key K17 is placed above the left-end selection key K17. In other words, the selection keys K17 are arrayed in a staggered arrangement. With such an arrangement adopted, the distance between adjacent selection keys K17 can be increased without changing the left and right width, as compared with the case where the selection keys K17 are arrayed on a left and right straight line. Thus, the possibility of mis-presses can be reduced even if the selection keys K17 are arranged within a limited left-right size. Also, the selection keys K17 do not need to be downsized in area for larger distances of the selection keys K17.

The various keys K11 to K18 for use in the present preferred embodiment are formed integrally with a membrane sheet bonded onto the front face of a cover of the housing 60 as a nameplate. In more detail, in a membrane sheet formed from a synthetic resin sheet, there are formed swelling portions that protrude forward, where electrodes serving as switch contacts are formed in correspondence to the swelling portions. The membrane sheet is formed by laminating two sheets together with each other, where fixed-side electrodes having discontinuities are formed on one sheet while movable-side electrodes are formed at the swelling portions provided in the other sheet. Thus, this provides such a structure that pressing each swelling portion causes each corresponding movable-side electrode to be bridged in contact over discontinuous parts of the fixed-side electrodes, thereby making the fixed-side electrodes conducting. Hereinafter, the membrane sheet equipped with the keys K11 to K18 is referenced to as a membrane switch 30.

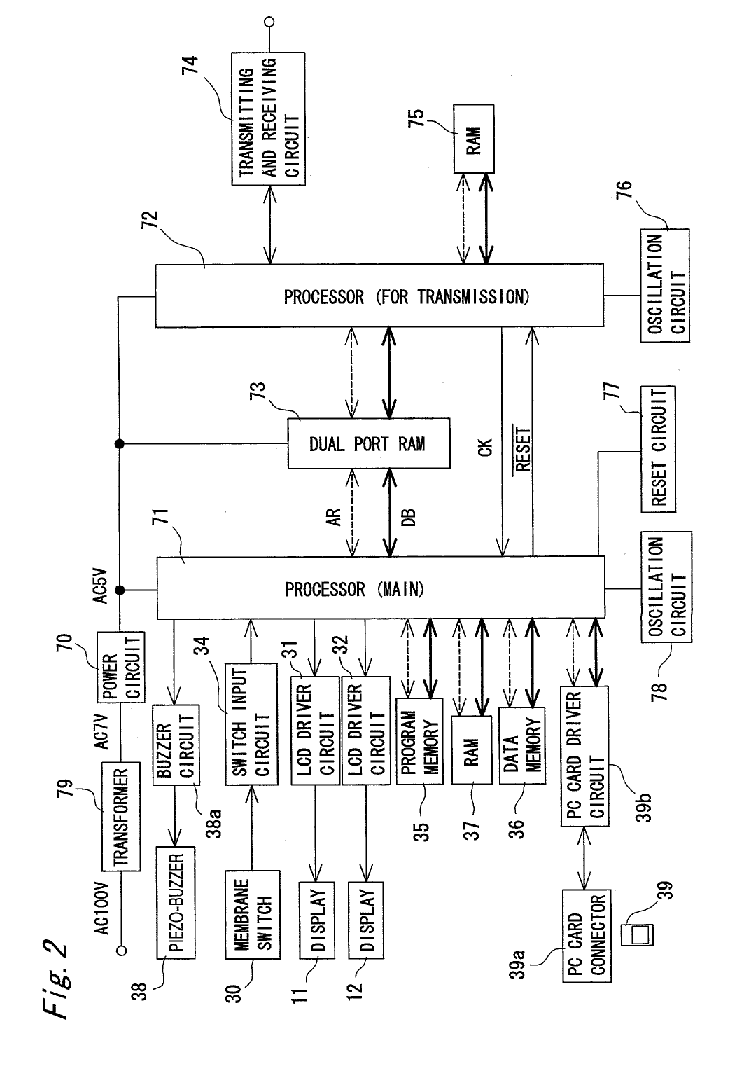

The selector switch unit 1 as described in the present preferred embodiment has a constitution or structure shown in FIG. 2. The selector switch unit 1 basically has a processor 71 for implementing the above-described functions, and a processor 72 which is connected to a signal line 44 to achieve the function of transmitting and receiving a transmission signal Vs to and from a transmission unit 41, where a dual port memory (RAM) 73 for sharing data between the two processors 71 and 72 is provided. These components are connected to one another via a data bus DB and an address bus AR. The processor 72 includes a transmitting and receiving circuit 74 for transmitting and receiving a transmission signal Vs to and from the transmission unit 41. The processor 72 is further provided with a RAM 75 for use in working by the processor 72 as well as an oscillation circuit 76 for generating a clock signal. The processor 71 is provided with a reset circuit 77 and an oscillation circuit 78 for generating a clock signal. The power for the selector switch unit 1 is supplied from a commercial power supply, and the voltage of the commercial power supply is stepped down by a transformer 79 and stabilized by a power circuit 70, this leading to an internal power supply.

The display units 11 and 12 are connected to the processor 71 via LCD driver circuits 31 and 32, respectively, and operations of the membrane switch 30 are inputted to the processor 71 through a switch input circuit 34. Programs for determining the operation of the processor 71 are stored in a program memory 35 formed of a flash memory, and prepared data are stored into a data memory 36 formed of a flash memory. A RAM 37 for use in working is also connected to the processor 71. Further provided are a piezo-buzzer 38 to be used for generating operation sounds in operations of the keys K11 to K18, a buzzer circuit 38a for driving the piezo-buzzer 38, and a PC card connector 39a for connecting a PC card 39 to be used for backup of data stored in the data memory 36 as well as a PC card driver circuit 39b.

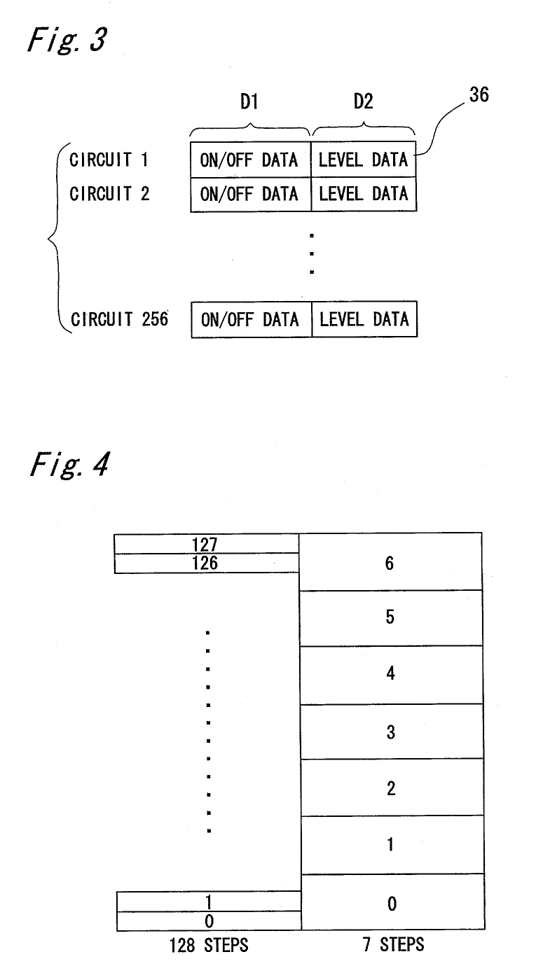

By the way, the present invention is characterized by the selector switch unit 1 that allows the states of multiple circuits to be seen in a list, where setting of dimming level is enabled. For this purpose, as shown in FIG. 3, the data memory 36 has not only an ON/OFF data storage area D1 for storing therein ON/ OFF data of the illumination loads L set for the individual circuits, respectively, by the selection keys K17, but also a level data storage area D2 for storing therein dimming levels for the individual circuits, respectively. Accordingly, it is possible to set ON/OFF data and level data for each circuit. In the preferred embodiment, the number of circuits is 256 as described above, and the level data for each circuit can be set in 128 steps.

Next, setting operation in the selector switch unit 1 of the present remote monitoring and controlling system will be explained. For the setting of the dimming level for the individual circuits in batch control, the following operation is performed. First of all, the type of batch control is selected by the function selection keys K16, and a pattern number or a group number is inputted by the ten key K11. Thereafter, by pressing selection keys K17 corresponding to a desired circuit, the illumination load L for the circuit is set to turning ON or OFF. In this case, since the circuits that have been set to ON out of the dimming-controllable circuits allow a dimming level to be set, dimming control is selected from the function selection keys K16 for the setting of a dimming level, and a desired dimming level is displayed on the display units 12 by operation of the arrow keys K13. Thus, by performing these operations, dimming levels are displayed at the sites corresponding to the circuits for which turning ON has been selected by the selection keys K17 in the display units 12. The arrow keys K13 are composed of two keys including an up key and a down key, where pressing the up key once causes the level data to go up one step, and also, pressing the down key once causes the level data to go down one step. As widely adopted for this kind of operation, the up key and the down key are so designed that pressing these keys for more than a certain time duration (several seconds) causes the level data to continuously change. The ten key K11 may also be used when the dimming level can be inputted in numerical values. After the dimming level is set in association with the selection keys K17 in this way, pressing the execution key K15 allows the ON/OFF data and the level data to be stored into the data memory 36. It is to be noted here that these operations of keys are given as an example, and for cases where the dimming control is frequently performed, keys for instructing the setting of dimming level or keys for changing the dimming level may also be provided for higher operability, in addition to the function selection keys K16 and the arrow keys K13.

Although the dimming level can be set in 128 steps for each circuit as already described above, dividing the dimming range of illumination loads into 128 steps would result in such a degree of optical output change corresponding to one step as could hardly be recognized visually. Indeed, given such a settability of dimming level in multiple steps, when optical output of an illumination load is continuously changed with time elapse as in fade-in or fade-out, it would be possible to make the optical output recognized as if the optical output were continuous, without consciousness of the variations in optical output at the individual steps. However, if there is no need for continuously changing the optical output with time elapse, it is not necessary to set the optical output in such a large number of steps. Thus, for such cases, it is desirable to change the dimming level in such a smaller number of steps as visually recognizable steps of changes can be obtained. For example, if dimming levels divided in 128 steps are set into correspondence to 7 steps as shown in FIG. 4 and if the dimming level is changed in 7 steps with the use of the arrow keys K13, then the number of operations required for the setting of dimming level is reduced, and moreover a practical setting of dimming level from the viewpoint of visual characteristics becomes possible. In this case, although the correspondent association from 128 steps to 7 steps may be done with equal steps of changes (i.e., each 18 steps of dimming levels divided into 128 steps are set into correspondence to one step of division into 7 steps), yet it is appropriate to make such unequal correspondence in view of visual characteristics that step-by-step changes in optical output in the case of division into 7 steps are generally equally recognized visually.

The above-described procedure enables the setting of dimming levels also in batch control such as pattern control or group control. However, even if dimming level is inputted at the time of setting, the set data will not be reflected on optical output of the illumination load until transferred to the transmission unit 41, so that it cannot be known at the time of setting what degree of brightness the set dimming level becomes actually. Accordingly, the technique for setting the dimming level on confirmation of brightnesses corresponding to dimming levels is explained below.

In this case, by taking advantage of the fact that the transmission unit 41 transmits the ON/OFF information and dimming level of the illumination load of each circuit to the dimming terminal unit 2 by the transmission signal Vs, it is arranged that a dimming level for batch control is set by receiving a dimming level from the transmission signal Vs and using the current dimming level of the illumination load as it is, thus making it possible to set a dimming level on confirmation of actual brightness of the illumination load. In this case, ON/OFF data and dimming level data contained in the transmission signal Vs together with each other will be referred to as “circuit state data” hereinafter. Although the setting for pattern control will described below, similar techniques may be applied also to the setting for group control. In the group control, since all the illumination loads become to an equal dimming level, the setting for group control is easier than that for pattern control. Concretely, the following two types of techniques are available for performing the setting for pattern control by receiving the circuit state data from the transmission signal Vs.

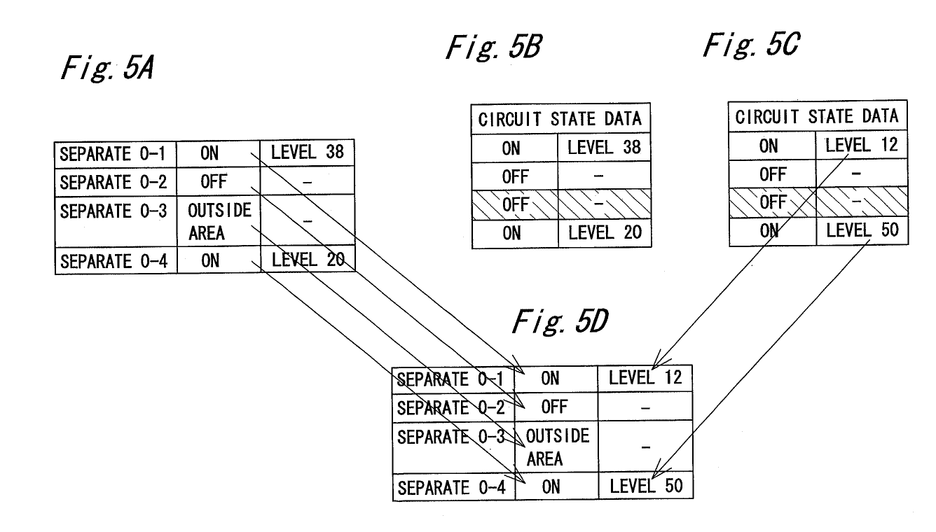

In the first technique, a state of ON or OFF for each circuit is first of all set by using the selection keys K17 at the time of setting for pattern control. In this setting, information as to “ON”, “OFF” or “OUTSIDE AREA” is set for each circuit as shown in FIG. 5A. Although dimming levels are set in FIG. 5A, any values may be assumed as the dimming levels in this case. After data as to which illumination loads are set to “ON” in pattern control is set, this data is transferred to the transmission unit 41, and then the pattern control is performed. At this stage, circuit state data containing dimming levels of illumination loads as shown in FIG. 5B are transferred from the transmission unit 41 to the dimming terminal units 2 by the transmission signal Vs.

Next, by using a wall switch for use of dimming control or by performing the same operations as those in the above-described setting of dimming levels (operations including selection with the selection keys K17, selection of dimming control with the function selection keys K16, and setting of dimming levels with the arrow keys K13), dimming levels of the illumination loads are set so that the actual brightnesses of the illumination loads are changed. In this case, such circuit state data containing dimming levels of the illumination loads as shown in FIG. 5C is transferred from the transmission unit 41 to the dimming terminal units 2 by the transmission signal Vs. Then, with desired illumination loads at desired brightnesses, selecting an operation of “SCENE STORAGE” with the display unit 11 (i.e., selecting an option displayed on the display unit 11 is equivalent to a scene storage unit) is followed by checking between the data as to ON/OFF state of the individual illumination loads used for the pattern control and the circuit state data transferred by the transmission unit 41 to the individual dimming terminal units 2. In this case, with respect to circuits for which ON state has been selected in the data of pattern control (FIG. 5A), dimming levels are extracted from the circuit state data (FIG. 5C), and data for pattern control are prepared by combining together the two kinds of data, as shown in FIG. 5D. The data for pattern control prepared in this way are given (i.e., overwritten with) the same pattern numbers as those of the original data for pattern control (data of FIG. 5A) and stored into the data memory 36. By setting dimming levels for pattern control with such a procedure, data of pattern control can be set after user's confirmation of brightnesses corresponding to the dimming levels.

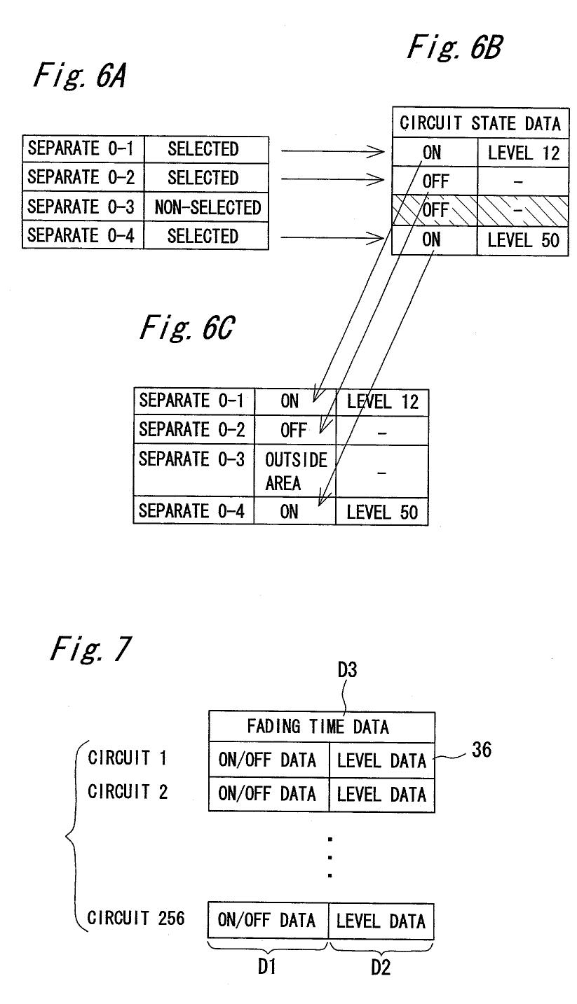

In the second technique, rather than performing the setting for pattern control as that in the first technique, first of all, as shown in FIG. 6A, a choice between “SELECTED” and “NON-SELECTED” is predetermined for each circuit with the selection keys K17. That is, it is predetermined whether or not the circuit state data of the transmission signal Vs is used as data for pattern control. In short, it is selected whether or not each circuit is targeted for pattern control. In this case, for taking correspondence between operations of the selection keys K17 and the choices of “SELECTED” and “NON-SELECTED”, a mode is preliminarily selected from within the screen of the display unit 11. Upon completion of the specifications with the selection keys K17, circuit state data is acquired from the transmission signal Vs as shown in FIG. 6B, by which current ON/OFF states and dimming levels of the illumination loads with respect to the “SELECTED” circuits can be known. That is, with desired illumination loads set at desired brightnesses by a wall switch or the like, ON/OFF states and dimming level data of the illumination loads can be captured into the selector switch unit 1. In this case, selecting an operation of “SCENE STORAGE” with the display unit 11 leads to the extraction of circuit state data contained in the transmission signal Vs with respect to the “SELECTED” circuits, and data for pattern control are prepared as shown in FIG. 6C. By setting dimming levels for pattern control with such a procedure, data of pattern control can be set after confirmation of brightnesses corresponding to the dimming levels.

Upon doing dimming control, there are some cases where fade-in (an operation that optical output is increased with time elapse) or fade-out (an operation that optical output is decreased with time elapse) are performed. Hereinafter, fade-in and fade-out together will be referred to as fade. In conjunction with the fade, the direction of a change in the optical output is determined by ON/OFF information set to the transmission unit 41, and the time of the change is determined by fade time set to the transmission unit 41. The fade time corresponds to the inclination of the optical output to the time axis. This means that making the fade time changed causes the rate of change of optical output to be changed. In batch control, the fade time never differs among individual illumination loads, and illumination loads targeted for batch control become equal in fade time to one another. Therefore, in batch control, the fade time has only to be determined by only one fade time irrespectively of the number of illumination loads. In order to enable such a fade function from the selector switch unit 1, in the present preferred embodiment, a fade time storage area D3 for storing therein fade time data is additionally provided in the data memory 36 as shown in FIG. 7.

Thus, in order to perform the fade control, the setting of fade time data to the fade time storage area D3 can be achieved by setting ON/OFF data and level data as data for batch control with the above-described procedure, and thereafter, selecting the use of the fade function from the screen of the display unit 11, and then inputting the fade time. In this case, although the ten key K11 may be used for the input of the fade time, yet it is desirable to provide such an arrangement that selecting the fade with the display unit 11 causes a plurality of options as to the fade time to be displayed on the display unit 11, where fade time is selected from among the options.

Next, data transfer to be performed from the selector switch unit 1 to the transmission unit 41 in the present remote monitoring and controlling system will be explained. After data for use in batch control are set to the data memory 36 of the selector switch unit 1 in the manner as described above, these data are transferred to the transmission unit 41 in a procedure as described below. It is to be noted here that for the transfer of data to the transmission unit 41, an interrupt signal Vi is outputted, as in the operation terminal units 42 connected to the signal line 44, so as to be recognized by the transmission unit 41. That is, for the transfer of data from the selector switch unit 1 to the transmission unit 41, it is not done that any special mode is set, but it is done that idle time during the normal operation in which illumination loads L are controlled is utilized.

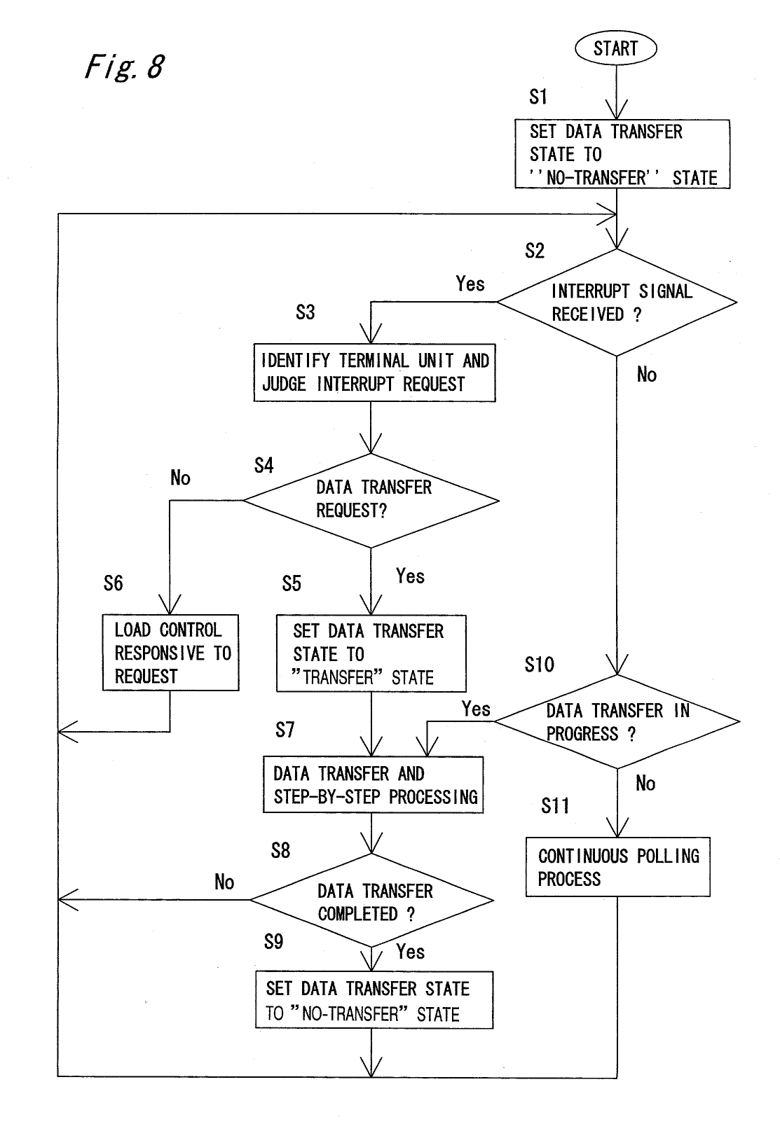

For this purpose, three steps of processing, preprocess, transfer process and post-process, and are performed for data transfer. Referring to FIG. 8, the transmission unit 41 first initializes the data transfer state as a “No-Transfer” state on power-up (S1), and then detects the presence or absence of an interrupt signal Vi as the preprocess (S2), where if an interrupt signal Vi is present, it is decided whether or not the interrupt signal Vi is derived from the selector switch unit 1 in the same way as that in the normal interrupt polling (S3), and further it is decided whether or not the signal is a data transfer request for batch control (S4). In this case, if it is a data transfer request signal, it is decided that data transfer is “Requested”, and data area of 256 bytes for data transmission and reception are ensured in the memory (S5). In the present preferred embodiment, data of 256 bytes are taken as the unit for data holding (for 256 circuits), and data of 256 bytes are treated as one page. Now that one page has been ensured, the transmission unit 41 notifies the selector switch unit 1 of that, starting the transmission of data. In addition, if the signal is not any data transfer request signal, it is decided that the signal is a normal interrupt signal Vi from an operation terminal unit 42, where illumination load control is performed (S6).

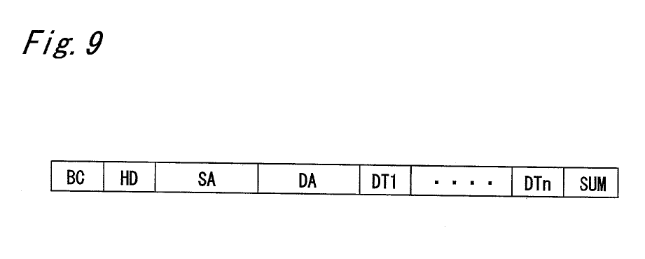

Data format of a signal used in the data transfer from the selector switch unit 1 to the transmission unit 41 is as shown in FIG. 9. Reference character BC denotes a byte counter which shows the count number of transfer data, HD denotes a header which is data for data discrimination, SA is a source address which shows a transmission-source address, DA denotes a destination address which shows a transmission-destination address, DT1 to DTn denote data to be transferred, and SUM denotes a check sum for checking transfer errors. Data is handled in the unit that one data is of one byte, and its head side corresponds to data of the lower-order address.

Accordingly, in the transfer process, as shown by step S7 in FIG. 8, transferred data is processed in the unit of one step (one byte) (S6) and then stored into the memory. When the data transfer is completed in this way (S8), the data transfer state is set to a “No-Transfer” state (S9). During the data transfer (S10), a process of segmenting and registering data in the unit of one byte as described above is performed. Also, when data transfer from the selector switch unit 1 to the transmission unit 41 is not completed by one-time transfer, the selector switch unit 1 re-generates an interrupt signal Vi, and then the same process is performed. If the data transfer is completed in this way, the program flow moves to the continuous polling (S11). It is to be noted that steps S8 and S9 are the post-process.

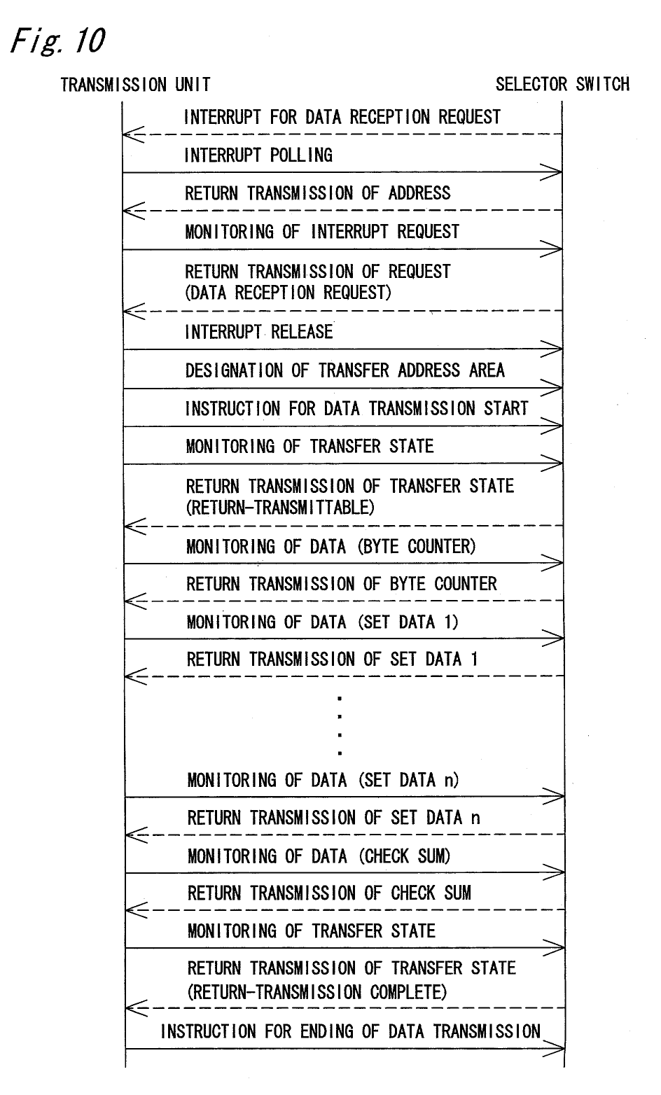

Data flow for the above processing is shown in FIG. 10. By these operations, the process of transferring the data for batch control to the transmission unit 41 can be performed during idle time of the process for controlling illumination loads without switching the operation. In this case, although a large amount of data to be transferred from the selector switch unit 1 to the transmission unit 41, when involved, might cause the traffic of a signal line Ls to increase to make an obstacle to the control of illumination loads, yet appropriately dividing the data to be transferred and transferring them in a plurality of times allows the data transfer to be achieved without any occurrence of such problems. Also, In this case, the processing of data transfer is set lower in priority than the processing of control of illumination loads, so that the control of the illumination loads is preferentially performed upon occurrence of the interrupt signal Vi associated with the control of the illumination loads.

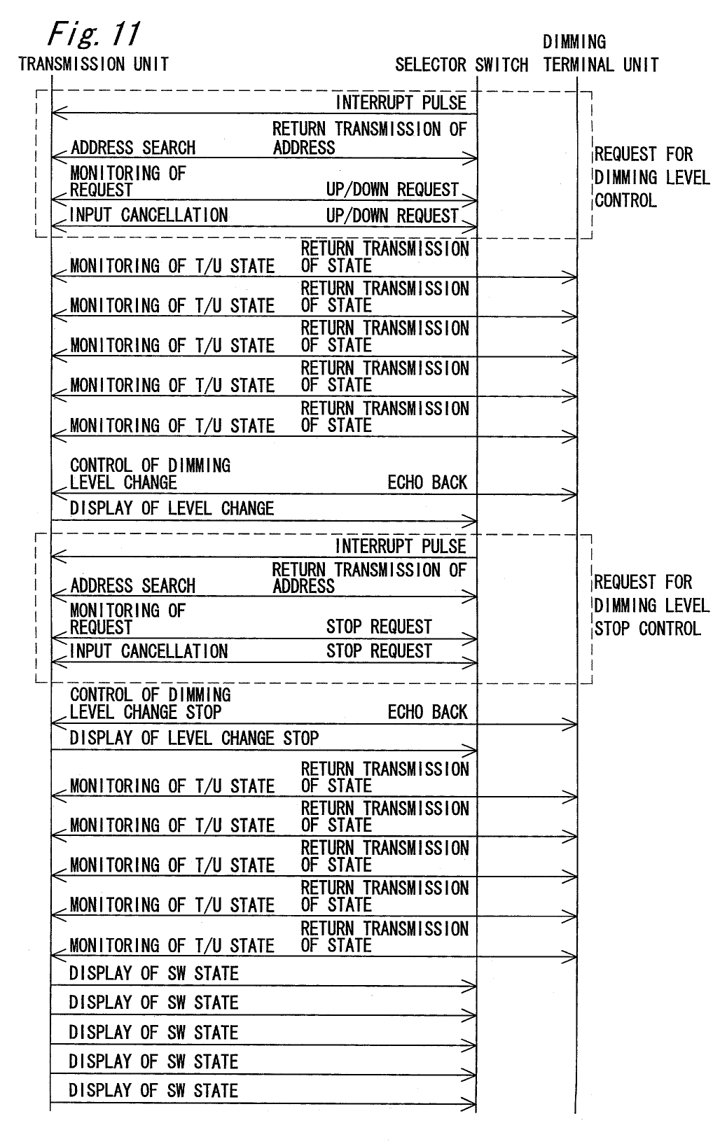

Next, the control operation of the present remote monitoring and controlling system will be explained. With the present remote monitoring and controlling system, in the dimming control for separate circuits of illumination loads, as shown in FIG. 11, a dimming level control request from the selector switch unit 1 to the transmission unit 41 is first performed. The normal mode is selected by the mode key K12, and separate control is selected by the up-and-down arrow keys K13 from among control types comprising separate control, old dimming control and group control. A separate circuit to be controlled is selected by the selection keys K17, and a dimming level is inputted for control exertion with the up-and-down arrow keys K13 again. In this case, the input for control exertion is effected while the arrow keys K13 are kept pressed, where level-up input is requested for control exertion while the upward arrow key K13 is kept pressed, and level-down input is requested for control exertion while the downward arrow key K13 is kept pressed. Upon receiving this request, the transmission unit 41 verifies the state of a control-targeted dimming terminal unit 80 previously associated by address setting, and then transfers an instruction for dimming level change control to this dimming terminal unit 2. The dimming terminal unit 2 that has received this instruction changes the dimming level according to the instruction. Further, the transmission unit 41 transfers the instruction for level change display to the selector switch unit 1, so that the dimming level of the illumination load currently under control is displayed on the display unit 11.

Then, the operator performs control request while visually observing the illumination load that is under dimming control, and upon the confirmation that a desired dimming level has been attained, releases the arrow key K13 from pressing, and then this leads to that a dimming-level stop control request is effected from the selector switch unit 1. In response to receiving this stop control request, the transmission unit 41 transfers an instruction for dimming-level change stop control to the dimming terminal unit 2 to which the instruction for dimming-level change control has been transferred, and moreover, stops the instruction for level change display to the selector switch unit 1. Thereafter, the transmission unit 41 verifies the state of the dimming terminal unit 80 that has been subjected to dimming control of the illumination load, and then displays the current dimming level of the illumination load on the display unit 11.

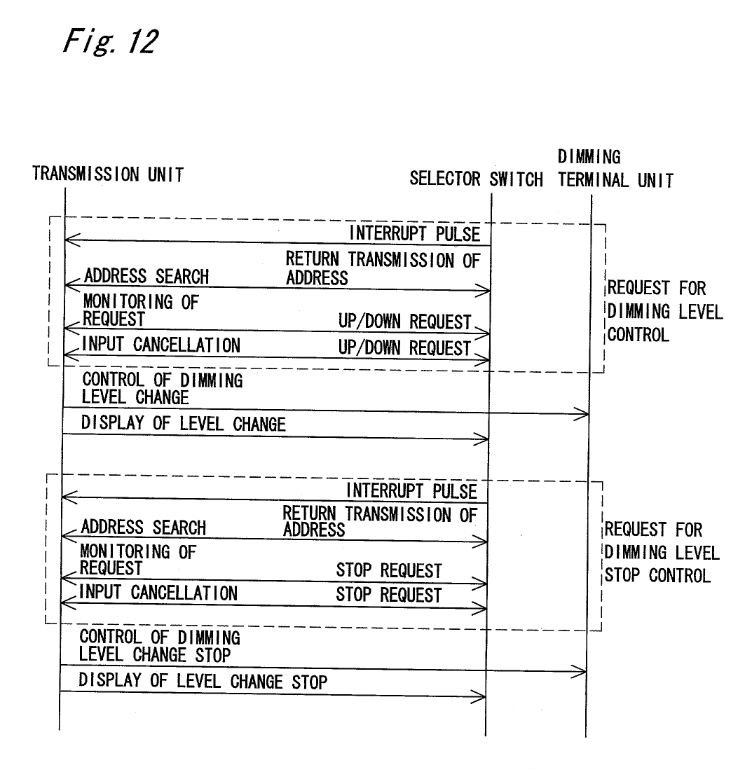

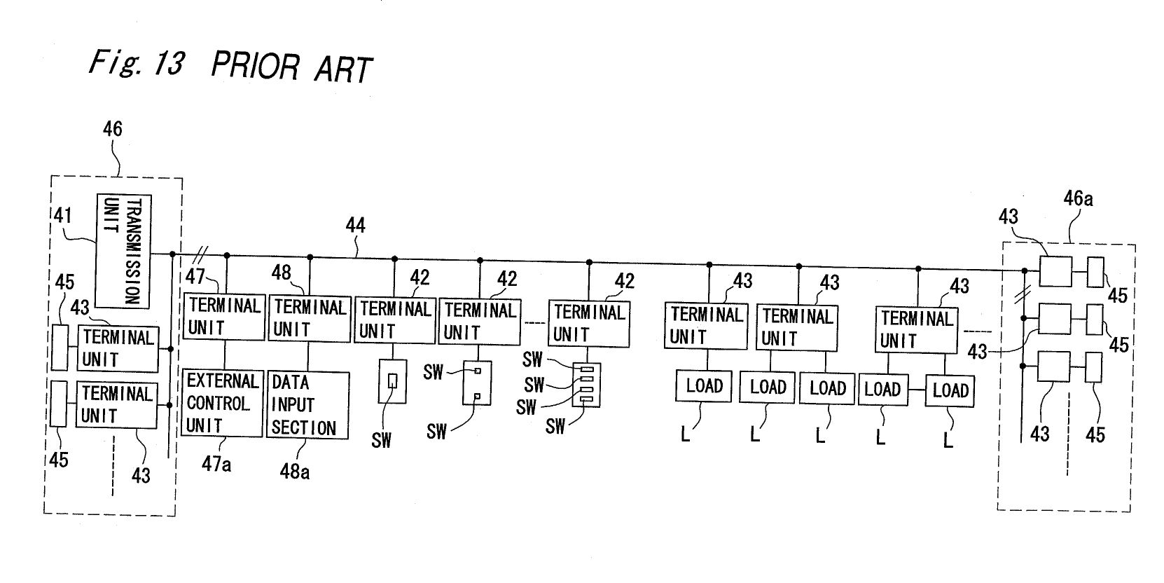

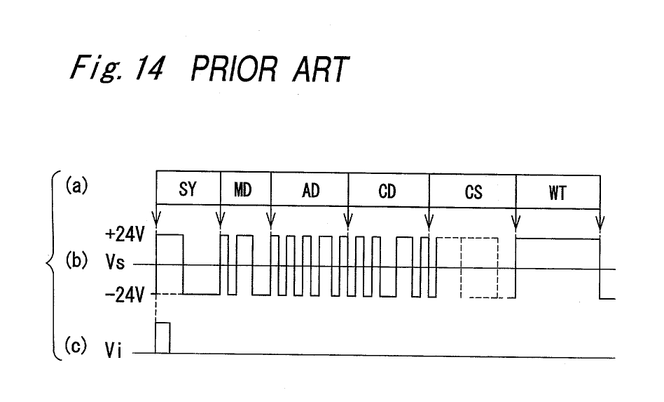

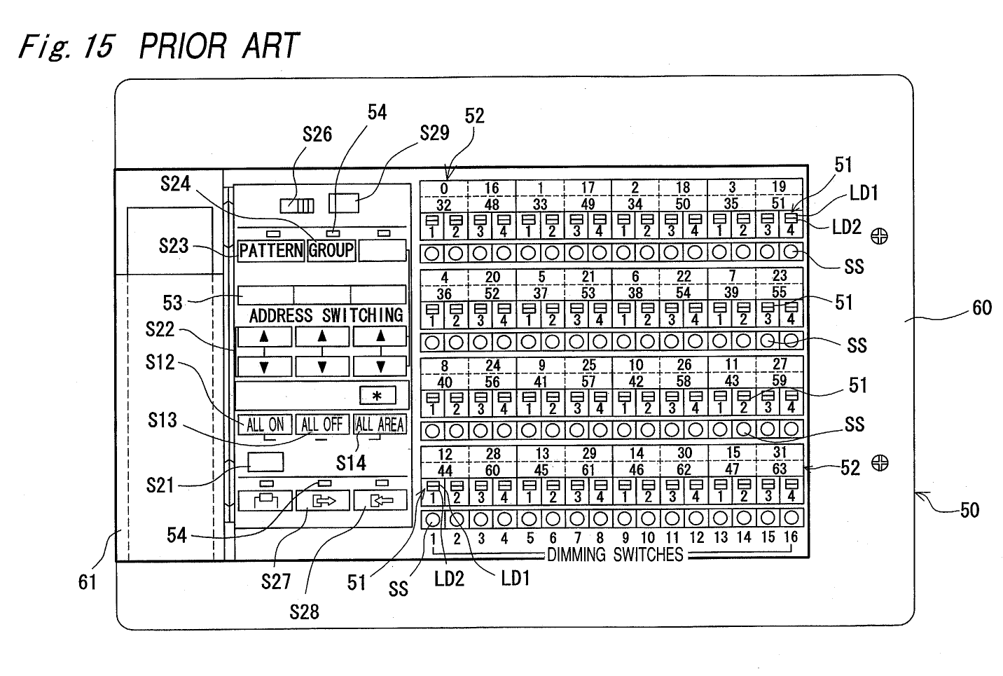

Next, a case where a plurality of illumination loads are batch-controlled in dimming will be described with reference to FIG. 12. As in the case of dimming control for separate circuits, a dimming level control request is first of all performed from the selector switch unit 1 to the transmission unit 41. The normal mode is selected with the mode key K12, and group control is selected by the up-and-down arrow keys K13 from among control types including separate control, old dimming control and group control. Then, the type of batch control is selected by the function selection keys K16, and a group number is inputted by the ten key K11. A control request for level-up input or level-down input is performed by pressing the up-and-down arrow keys K13 again. Upon receiving this request, the transmission unit 41 transfers an instruction for dimming level change control to a control-destination dimming terminal unit 80 preliminarily associated in correspondence by address setting. The dimming terminal unit 80 that has received this instruction collectively changes the dimming levels of illumination loads in the block, which have preliminarily been set as a group, according to the instruction. Further, the transmission unit 41 transfers the instruction for level change display to the selector switch unit 1, so that the dimming level of the illumination loads currently under batch control is displayed on the display unit 11. Thus, the setting and control for dimming control in separate control and batch control becomes possible. Also, the control for multiple circuits can be achieved with one selector switch unit, which is convenient for operational verification of setting contents.

Although all the illumination loads are controlled by using the selector switch unit 1 in the present preferred embodiment, the present invention is not limited to this. While the selector switch unit 1 is used exclusively for operational verification of setting contents, switches for separate control or switches for pattern control and group control may be separately provided on the wall and, normally, used to control the illumination loads.

According to the preferred embodiment of the present invention, the remote monitoring and controlling system enables the setting and control for separate control and batch control including dimming control, and yet allows the setting for multiple circuits to be easily achieved, and moreover enables the centralized control of all the illumination loads with one selector switch unit, which is convenient for operational verification of setting contents.

Since the remote monitoring and controlling system eliminates the possibility of more than necessary multi-step switching in the setting of dimming level and allows the dimming level to be set in such a coarse one as can be recognized visually, the remote monitoring and controlling system serves practical use and facilitates the setting operation for dimming level. In particularly, with the use of an operation section in which the dimming level changes one step for each one press in the setting of dimming level, whereas multi-steps would take time and labor until a desired dimming level is reached, lessening the steps for setting the dimming level allows the time and labor to be reduced until a desired dimming level is attained.

Since the dimming level contained in the transmission signal transferred from the transmission unit to the control terminal unit is stored into the data memory, it becomes possible to set a dimming level on confirmation of actual optical output of the illumination load.

In the present remote monitoring and controlling system, with ON/OFF states of batch-control targets preliminarily determined, optical output of the set-ON illumination loads is actually adjusted before the dimming levels of the ON illumination loads are acquired from the transmission signal and set to the data memory. Thus, it becomes possible to prepare data for batch control including dimming control on confirmation of actual brightness.

In the present remote monitoring and controlling system, with illumination loads of batch-control targets preliminarily determined, the individual illumination loads are turned ON and OFF or optical output is adjusted, actually, before illumination load's turning ON/OFF and dimming level data only of the control-targeted illumination loads are acquired from the transmission signal and set to the data memory. Thus, it becomes possible to prepare data for batch control including dimming control on actual confirmation of control contents. Further, batch control including fade control becomes implementable.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

The present disclosure relates to the subject matter contained in the priority document of Japanese Patent Application No. P2001-085524, filed on Mar. 23, 2001, entitled “Remote monitoring and controlling system”, which is herein expressly incorporated by reference in its entirety.

What is claimed is:

1. A remote monitoring and controlling system comprising:
a selector switch unit connected to a signal line and having a predetermined address, said selector switch unit setting data for batch controlling and separately controlling operation of a plurality of illumination loads and transmitting to the signal line a control request signal related to operation for the plurality of illumination loads based on the set data;
a transmission unit, connected to the signal line, for transmitting and receiving a transmission signal to and from a plurality of dimming terminal units by using a preliminarily set correspondence relation of addresses between operation terminal units and the dimming terminal units based on a control request signal derived from said selector switch unit; and
a plurality of dimming terminal units connected to the signal line and having predetermined addresses, respectively, said plurality of dimming terminal units controlling dimming of illumination loads connected in correspondence to the individual dimming terminal units, respectively, in response to a transmission signal derived from the transmission unit,
wherein said selector switch unit comprises:
a first operation unit provided in correspondence to the plurality of illumination loads and equipped with a plurality of switches for inputting and setting operations of the plurality of illumination loads;
a second operation unit for inputting and setting correspondence between at least one of the plurality of switches and at least one illumination load;
a third operation unit for inputting and setting dimming levels of illumination loads in a unit of at least one illumination load among the illumination loads to which their operations and correspondence relation have been set by said first and second operation units;
a display unit for displaying setting contents and dimming levels set by said first to third operation units;
a data memory for storing therein operation states of the respective illumination loads set by said first and second operation units and dimming levels of the respective illumination loads set by said third operation unit, so that the operation states and the dimming levels are associated in correspondence therebetween; and
a transfer unit for transferring a control request signal containing the data stored in said data memory to said terminal unit, and
wherein said terminal unit transmits a dimming-level instruction signal to its corresponding dimming terminal unit based on a control request signal of dimming level derived from said selector switch unit, and further transmits a display instruction signal of dimming level to said selector switch unit, thereby displaying a current dimming level on said display unit.

2. The remote monitoring and controlling system as claimed in claim 1,
wherein the dimming level has a plurality of steps, and changes in optical output from an illumination load between mutually adjacent steps are set so as to be visually recognizable.

3. The remote monitoring and controlling system as claimed in claim 1,
wherein said selector switch unit receives a dimming level contained in a transmission signal transmitted from the transmission unit to the dimming terminal unit and stores the dimming level into said data memory.

4. The remote monitoring and controlling system as claimed in claim 3,
wherein, with operation states of a plurality of illumination loads stored and set to the data memory, and under control of dimming levels of a plurality of illumination loads based on the transmission signal, said selector switch unit comprises a first scene storage unit for receiving from the transmission signal a dimming level for each of the illumination loads the operation state of which has been set to ON state in said data memory and for setting the dimming level to said data memory.

5. The remote monitoring and controlling system as claimed in claim 3,
wherein, with operation states of a plurality of illumination loads inputted and set by said first operation unit, and under control of dimming levels of a plurality of illumination loads based on the transmission signal, said selector switch unit comprises a second scene storage unit for receiving from the transmission signal an operation state and a dimming level for the plurality of illumination loads the operation state of which has been set to ON state in said data memory and for setting the operation state and dimming level to said data memory.

6. The remote monitoring and controlling system as claimed in claim 1,
wherein said second operation unit comprises a selection unit for selecting and setting a fade operation mode in which optical output from each illumination load is increased or decreased with time elapse;
wherein said data memory further stores fade time showing a rate of change of optical output per unit time in the fade mode; and
wherein said transmission unit transmits a dimming level instruction signal to its corresponding dimming terminal unit based on a control request signal of dimming level containing the stored fade time derived from said selector switch unit so that a corresponding illumination load executes fade operation.
